(19) United States
(12) Patent Application Publication
(10) Pub. No.: US 2024/0412440 A1
(43) Pub. Date: Dec. 12, 2024

(54) FACIAL ANIMATION USING EMOTIONS FOR CONVERSATIONAL AI SYSTEMS AND APPLICATIONS

(71) Applicant: NVIDIA Corporation, Santa Clara, CA (US)

(72) Inventors: Rui Zhang, Beijing (CN); Zhengyu Huang, Zhejiang (CN); Lance Li, Beijing (CN); Weihua Zhang, Beijing (CN); Yingying Zhong, Anhui (CN); Junjie Lai, Beijing (CN); Yeongho Seol, Seoul (KR); Dmitry Korobchenko, Yerevan (AM)

(21) Appl. No.: 18/329,831

(22) Filed: Jun. 6, 2023

(51) Int. Cl. G06T 13/40; G06N 3/045; G06N 3/094; G10L 25/30; G10L 25/63

(52) U.S. Cl. CPC G06T 13/40; G06N 3/045; G06N 3/094; G10L 25/30; G10L 25/63

(57) ABSTRACT

In various examples, techniques are described for animating characters by decoupling portions of a face from other portions of the face. Systems and methods are disclosed that use one or more neural networks to generate high-fidelity facial animation using inputted audio data. In order to generate the high-fidelity facial animations, the systems and methods may decouple effects of implicit emotional states from effects of audio on the facial animations during training of the neural network(s). For instance, the training may cause the audio to drive the lower face animations while the implicit emotional states drive the upper face animations. In some examples, in order to encourage more expressive expressions, adversarial training is further used to learn a discriminator that predicts if generated emotional states are from real distribution.

### BACKGROUND

Many applications, such as gaming applications, interactive applications, communications applications, multimedia applications, and/or the like, use animated characters or digital avatars that interact with users of the applications and/or other animated characters within the applications. In order to provide more realistic experiences for the users, some animated characters interact using both audio, such as speech, as well as visual indicators. For example, when an animated character is interacting with a user, an application may both sync the lip movements of the animated character with speech being output by the animated character while also causing the animated character to visually express facial emotions. Visually expressing facial emotions may include causing the animated character to move various features of the face, such as the eyes, the eyebrows, the nose, the cheeks, and/or other features of the face.

As such, various techniques have been developed in order to provide more realistic facial animations associated with animated characters. For example, voice operated character animation (VOCA) is a technique that uses a one-hot identify encoding to control the speaking style of different animated characters. For instance, VOCA mainly learns casual facial motions from speech, which is mostly present in the lower face motions, such as the mouths of the animated characters. However, VOCA is unable to reconstruct the upper face motions of the animated characters. Because of this, VOCA is unable to fully provide facial expressions for conversational realism when interacting.

FaceFormer is a second technique that uses an autoregressive transformer-based architecture to improve the performance of speech-driven three-dimensional (3D) facial animation. For instance, FaceFormer effectively uses a self-supervised pretrained speech model to perform the 3D facial animation. However, FaceFormer still has many drawbacks when performing 3D facial animation, such as not being able to be applied in real-time since FaceFormer needs to capture long-range audio context dependencies. Additionally, FaceFormer may not extract semantic features, which makes FaceFormer incapable of enabling explicit control of emotions.

Meshtalk is a third technique that decouples audio-correlated and audio-uncorrelated information. By performing such decoupling, Meshtalk ensure highly accurate lip motion while also synthesizing plausible animation of parts of the face that are uncorrelated to the audio, such as the eye blinks or the eyebrow motion. However, in order to train a neural network associated with Meshtalk, a large dataset is required. For example, a large dataset that includes 13or more hours of paired audio-visual examples with 250 or more characters may be required to train the neural network. As such, training the neural network associated with Meshtalk also requires a large amount of computing resources and/or a long period of time. Additionally, and similar to FaceFormer, Meshtalk does not extract semantic features, which makes Meshtalk incapable of enabling explicit control of emotions.

### SUMMARY

Embodiments of the present disclosure relate to animating characters using facial emotions for conversational artificial intelligence (AI) systems and applications. Systems and methods are disclosed that use one or more neural networks to generate high-fidelity facial animation using inputted audio data. In order to generate the high-fidelity facial animation, the systems and methods may decouple effects of implicit emotional states from effects of audio on the facial animations during training of the neural network(s). For instance, the training may cause the audio to drive the lower face animations while the implicit emotional states drive the upper face animations. In some examples, in order to encourage more expressive animations, adversarial training is further used to learn a discriminator that predicts if generated emotional states are from a real distribution.

In contrast to conventional systems, such as conventional systems that perform the techniques described above (e.g., FaceFormer, Meshtalk, etc.), the current systems, in some embodiments, are able to generalize facial animation on multiple animated characters. For instance, the current systems may train the neural network(s) based on a single animated character, but then adapt the training to new animated characters using the processes described herein. As such, the current systems are able to train the neural network(s) using a small dataset, such as a small dataset that includes 3-5 minutes of high-quality visual-audio pairs for a single animated character. Because of this, the current systems may save computing resources and/or time when training the neural network(s) as compared to the conventional systems.

Additionally, in contrast to conventional systems, such as the conventional systems that perform the techniques described above, the current systems, in some embodiments, may use explicit emotions to control the major style expressions and implicit emotions to add more variant details. For instance, and as discussed above, conventional systems do not consider emotional reconstruction and/or may only extract one speaking style for each character. Additionally, while the conventional systems may construct a latent space for expressions, the conventional systems may not extract the semantic features, which causes the conventional systems to be incapable of enabling explicit control of emotions. In contrast, the current systems are capable of enabling such explicit control of emotions by using the explicit emotions to control the style expressions and the implicit emotions to add the more variant details.

### BRIEF DESCRIPTION OF THE DRAWINGS

The present systems and methods for animating characters using facial emotions for conversational AI systems and applications are described in detail below with reference to the attached drawing figures, wherein:

FIG. 1 illustrates an example data flow diagram for a process of using a neural network(s) to animate a character using facial animations, in accordance with some embodiments of the present disclosure;

FIG. 2 illustrates an example of a neural network(s) used to animate a character using facial animations, in accordance with some embodiments of the present disclosure;

FIG. 3 is a data flow diagram illustrating a first process for training a neural network(s) to animate a character using facial animations, in accordance with some embodiments of the present disclosure;

FIG. 4 is a data flow diagram illustrating a first process for training the neural network(s) associated with the example of FIG. 2, in accordance with some embodiments of the present disclosure;

FIG. 5 is a data flow diagram illustrating a second process for training a neural network(s) to animate a character using facial animations, in accordance with some embodiments of the present disclosure;

FIG. 6 is a data flow diagram illustrating a second process for training the neural network(s) associated with the example of FIG. 2, in accordance with some embodiments of the present disclosure;

FIG. 7 illustrates an example of allowing a user to further control facial animations associated with characters, in accordance with some embodiments of the present disclosure;

FIG. 8 is a flow diagram showing a method for using a neural network(s) to animate a character using facial animations, in accordance with some embodiments of the present disclosure;

FIG. 9 is a flow diagram showing a method for training a neural network(s) to animate a character using facial animations, in accordance with some embodiments of the present disclosure;

FIG. 10 is a flow diagram showing a method for controlling facial animations associated with an animated character, in accordance with some embodiments of the present disclosure;

FIG. 11 is a block diagram of an example content streaming system suitable for use in implementing some embodiments of the present disclosure;

FIG. 12 is a block diagram of an example computing device suitable for use in implementing some embodiments of the present disclosure; and

FIG. 13 is a block diagram of an example data center suitable for use in implementing some embodiments of the present disclosure.

### DETAILED DESCRIPTION

Systems and methods are disclosed related to animating characters using facial emotions for conversational AI systems and applications. For instance, a system(s) may use one or more neural networks to generate facial animations, such as high-fidelity facial animations, for animated characters or digital avatars associated with one or more applications. As described herein, an application may include, but is not limited to, a gaming application, an interactive application, a communications application, a video conferencing application, a multimedia application, a streaming application, an in-vehicle infotainment application, a digital assistant application, and/or any other type of application that may implement one or more animated or digital persons, characters, avatars, actors, objects, and/or the like. In some examples, the neural network(s) may be configured to generate the facial animations for the animated characters using one or more inputs, such as audio data representing one or more words and/or other types of sound. For instance, the audio data may represent user speech, computer-generated speech, speech from a text to speech (TTS) model, and/or any other type of speech.

In some examples, the neural network(s) may include multiple neural networks and/or layers that process the input(s) and, based at least on the processing, output data representing positions of vertices associated with the facial animations. For example, the neural network(s) may include, but is not limited to, one or more first neural networks (e.g., a backbone network) that process the input(s) (e.g., the audio data) in order to generate a first output, one or more second neural networks (e.g., a generator, a feedforward network, etc.) that process the first output in order to generate a second output associated with one or more implicit emotions, and one or more third neural networks (e.g., a formant analysis network, an articulation network, an output network, etc.) that process the first output and the second output in order to generate a final output that is then used for the facial animation. In some examples, the final output may represent a geometry dataset that includes a number of vertices (or information corresponding thereto, such as location and orientation) associated with positions on a face for animating a character. In some examples, principle component analysis (PCA) decomposition may be performed on the geometry dataset in order to reduce the number of vertices. By generating such a final output, the final output from the neural network(s) may be applied to numerous animated characters.

In some examples, such as to improve the facial animations, the neural network(s) may be trained in order to decouple the effects of the audio data from the effects of implicit emotional states on the facial animation. This way, in some examples, the audio data may mostly and/or only drive the lower face animation while the implicit emotional states mostly and/or only drive the upper face animations. For example, the audio data may mostly and/or only drive the animation associated with the lips, chin, cheeks, and/or other features of the lower face, while the implicit emotional states mostly and/or only drive the animation associated with the eyes, eyebrows, nose, forehead, and/or other features of the upper face.

For example, such as during a first training stage of the neural network(s), at least a first portion of the neural network(s) (e.g., the first neural network(s), the third neural network(s), etc.) may be trained in order to animate the lower facial expressions of an animated character. For instance, during this first training stage, the inputs to the neural network(s) may include at least audio data representing one or more words, data representing explicit emotional labels, and/or fake and/or randomly sampled geometry data associated with a face (e.g., geometry data that does not match the audio data). In some examples, the inputs include the fake and/or randomly sampled geometry data since this first training stage is associated with animating the lower facial expressions of the animated character. The system(s) may then use one or more loss functions to update the first portion of the neural network(s) (e.g., the parameters-e.g., biases and/or weights) based at least on one or more outputs and ground truth data. In some examples, the loss function(s) uses only a portion of the output(s), such as the portion of the output(s) representing the lower face of the animated character, to update the first portion of the neural network(s).

Additionally, such as during a second training stage of the neural network(s), at least a second portion of the neural network(s) (e.g., a fourth neural network(s), such as an encoder that may not be used at runtime of the neural network(s)) may be trained in order to animate the upper facial expression of the animated character. For instance, during this second training stage, the inputs to the neural network(s) may include at least geometry data associated with a face and fake audio data (e.g., audio data that does not match the geometry data). In some examples, the inputs include the fake audio data since the second training stage is associated with animating the upper facial expressions of the animated character and/or associated with determining implicit emotional states (e.g., vectors representing the implicit emotional states)—and doing so by teaching the model to (at least partially) ignore the audio when determining these outputs. The system(s) may then use one or more loss functions to update the second portion of the neural network(s) (e.g., the parameters—e.g., biases and weights) based at least on one or more outputs and ground truth data. In some examples, the loss function(s) uses only a portion of the output(s), such as the portion of the output(s) representing the upper face of the animated character, to update the second portion of the neural network(s).

Furthermore, such as during a third training stage of the neural network(s), at least a third portion of the neural network(s) (e.g., the second neural network(s), etc.) may be trained in order to predict the implicit emotional states at runtime. In some examples, the third portion of the neural network(s) may be trained to predict the implicit emotional states since the input(s) to the neural network(s), when deployed, may include audio data without any state and/or geometry data. For instance, during this third training stage, the inputs to the neural network(s) may include audio data and data representing emotional labels. The system(s) may then use one or more loss functions to update the third portion of the neural network(s) (e.g., the parameters—e.g., biases and/or weights) based on the emotional states output by the third portion of the neural network(s), which were learned during the first training stage and/or the second training stage (e.g., the input audio data may be paired with the label data representing the actual emotional states), and/or the emotional labels. In some examples, such as to generate more expressive expressions by the animated character, this third training stage may further include introducing adversarial training to learn a discriminator to predict if the generated emotional states are from a real distribution.

In some examples, such as after training the neural network(s), the system(s) may provide addition controls to allow one or more users to further manipulate the facial animations of an animated character. For instance, and as described herein, the neural network(s) may map geometries associated with faces from a first space (e.g., a PCA space) to a second space (e.g., an implicit emotional space). As such, the system(s) may be able to compute the implicit emotional vectors for various emotions and/or facial expressions, such as frowning, closing eyes, smiling, and/or so forth. For example, the system(s) may identify a first vector associated with a direction that causes the animated character to frown, a second vector associated with a direction that causes the animated character to close eyes, and/or the like. As such, the system(s) may allow the user(s) to perform linear manipulations associated with one or more of the vectors to further control the facial animations. For instance, if the user(s) only wants to the animated character to partially close the eyes, then the user(s) may manipulate the vector associated with closing the eyes.

The systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., an infotainment system of a machine or vehicle), systems implemented using a robot, aerial systems, medial systems, boating systems, smart area monitoring systems, systems for performing deep learning operations, systems for performing simulation operations, systems for performing digital twin operations, systems that implement language models—such as large language models, systems implemented using an edge device, systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems implemented at least partially using cloud computing resources, and/or other types of systems.

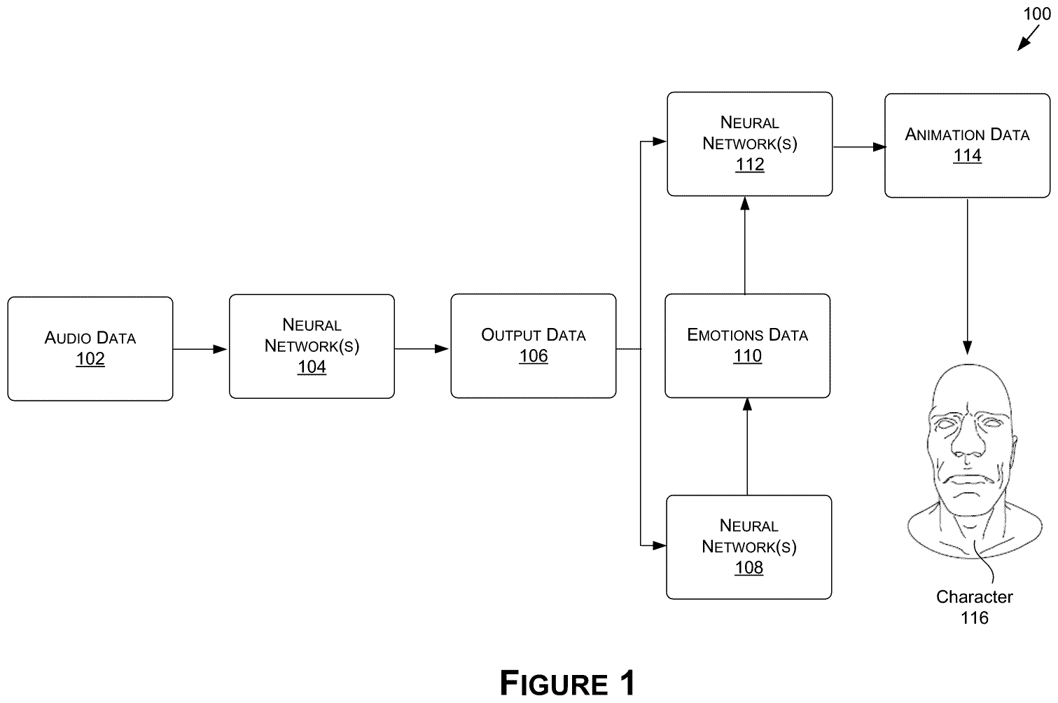

With reference to FIG. 1, FIG. 1 illustrates an example data flow diagram for a process 100 of using one or more neural networks to animate a character using facial animations, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

The process 100 may include receiving audio data 102 generated by one or more devices. As described herein, the audio data 102 may represent sound, such as one or more words, one or more numbers, one or more symbols, and/or the like. For a first example, the audio data 102 may represent speech from one or more users, such as speech captured by one or more microphones. For a second example, the audio data 102 may represent speech that is computer generated (e.g., using a TTS model or algorithm). In some examples, the audio data 102 may represent one or more audio frames that together represent the sound.

The process 100 may include processing the audio data 102 using one or more neural networks 104 (which may be referred to, in some examples, as a “first neural network(s) 104”) associated with a backbone. As described herein, the first neural network(s) 104 may include, but is not limited to, a convolutional neural network(s), a recurrent neural network(s), a transformer neural network(s), a feature-extracting neural network(s), a deep neural network(s), and/or any other type of neural network. For instance, and as shown, based on analyzing the audio data 102, the first neural network(s) 104 may output data 106 associated with the audio data 102. In some examples, the output data 106 may represent one or more vectors generated by the first neural network(s) 104, where vector(s) is based on sound represented the audio data 102. For example, if the audio data 102 represents one or more words, then the output data 106 may represent one or more vectors representing the one or more words. In some examples, the first neural network(s) 104 may include one or more components, such as one or more encoders, one or more decoders, and/or any other component.

The process 100 may include processing the output data 106 using one or more neural networks 108 (which may be referred to, in some examples, as a “second neural network(s) 108”) that are associated with determining one or more implicit emotional states, wherein the implicit emotional state(s) is represented by emotions data 110. As described herein, the second neural network(s) 108 may include, but is not limited to, a generator neural network(s), a convolutional neural network(s), a recurrent neural network(s), a transformer neural network(s), a feature-extracting neural network(s), a formant analysis neural network(s), a deep neural network(s), an articulation neural network(s), and/or any other type of network. In some examples, and as described in more detail herein, the second neural network(s) 108 is trained using feedback from a discriminator in order to improve the output of the second neural network(s) 108.

In some examples, the emotions data 110 may represent one or more vectors associated with the implicit emotional state(s). As described herein, an implicit emotional state may be associated with a neutral face (e.g., no emotion), a frowning face, a happy face, a sad face, a scared face, a face with closed eyes, a face with raised eyebrows, and/or a face that performs any other facial expression. For a first example, if the second neural network(s) 108 determines that an implicit emotional state includes a neutral face, then the emotions data 110 may represent a vector(s) associated with the neutral face. For a second example, if the second neural network(s) 108 determines that an implicit emotional state includes a frowning face, then the emotions data 110 may represent a vector(s) associated with the frowning face. For a third example, if the second neural network(s) 108 determines that an implicit emotional state includes partially closed eyes, then the emotions data 110 may represent a vector(s) associated with the partially closed eyes.

The process 100 may include processing the output data 106 and/or the emotions data 110 using one or more neural networks 112 (which may also be referred to, in some examples, as a “third neural network(s) 112”) that are associated with animating a character. As described herein, the third neural network(s) 112 may include, but is not limited to, a generator neural network(s), a convolutional neural network(s), a recurrent neural network(s), a transformer neural network(s), a feature-extracting neural network(s), a formant analysis neural network(s), a deep neural network(s), an articulation neural network(s), an output neural network(s), and/or any other type of network. For instance, and as shown, based on processing the output data 106 and/or the emotions data 110, the third neural network(s) 112 may generate and then output animation data 114.

In some examples, the animation data 114 may represent a geometry dataset that includes a number of vertices associated with positions on the face of a character 116. The number of vertices may include, but is not limited to, 100 vertices, 1,000 vertices, 60,000 vertices, 500,000 vertices, and/or any other number of vertices. Additionally, a vertex, from the number of vertices, may represent a three-dimensional (3D) location of a position on the face, such as a x-coordinate location, a y-coordinate location, and a z-coordinate location. In some examples, the 3D location includes a 3D point displacement relative to a neutral face or a neutral or origin location. Furthermore, in some examples, one or more techniques may be used in order to reduce the number of vertices represented by the animation data 114. For example, principal component analysis (PCA) decomposition may be performed on the geometry dataset in order to reduce the dimension of the output. The reduced dimension of the output (e.g., PCA coefficients) may include, but is not limited to, 50, 100, 140, 500, 1,000, and/or any other dimension of coefficients.

The process 100 may then include animating the character 116 using the animation data 114. For instance, the system(s) and/or another device that receives the animation data 114 from the system(s) may use the animation data 114 to animate the character 116. In some examples, animating the character 116 may include moving different points on the face of the character 116 according to the positions of the vertices included in the geometry dataset represented by the animation data 114. For example, if a first portion of the vertices are associated with positions on the lips of the character 116, then the animating may include moving points on the lips to match the positions associated with the first portion of the vertices. Additionally, if a second portion of the vertices are associated with positions on the cheeks of the character 116, then the animating may include moving points on the cheeks to match the positions associated with the second portion of the vertices. This process may repeat for one or more (e.g., all) of the vertices.

In some examples, the process 100 may continue to repeat as additional audio data 102 is received. For example, the process 100 may repeat such that animation data 114 is generated for groups of audio frames represented by the audio data 102. As described herein, a group of audio frames may include, but is not limited to, 1 audio frame, 10 audio frames, 50 audio frames, 100 audio frames, 1,000 audio frames, and/or any other number of audio frames. This way, the process 100 may include continuing to animate the character 116 as the additional audio data 102 continues to be received.

While the example of FIG. 1 illustrates the first neural network(s) 104, the second neural network(s) 108, and the third neural network(s) 112 as being separate from one another, in other examples, one or more of the first neural network(s) 104, the second neural network(s) 108, and the third neural network(s) 112 may be combined. For example, the first neural network(s) 104 may be included within the second neural network(s) 108 and/or the first neural network(s) 104 may be included within the third neural network(s) 112 such that the second neural network(s) 108 and/or the third neural network(s) 112 directly receive and/or process the audio data 102.

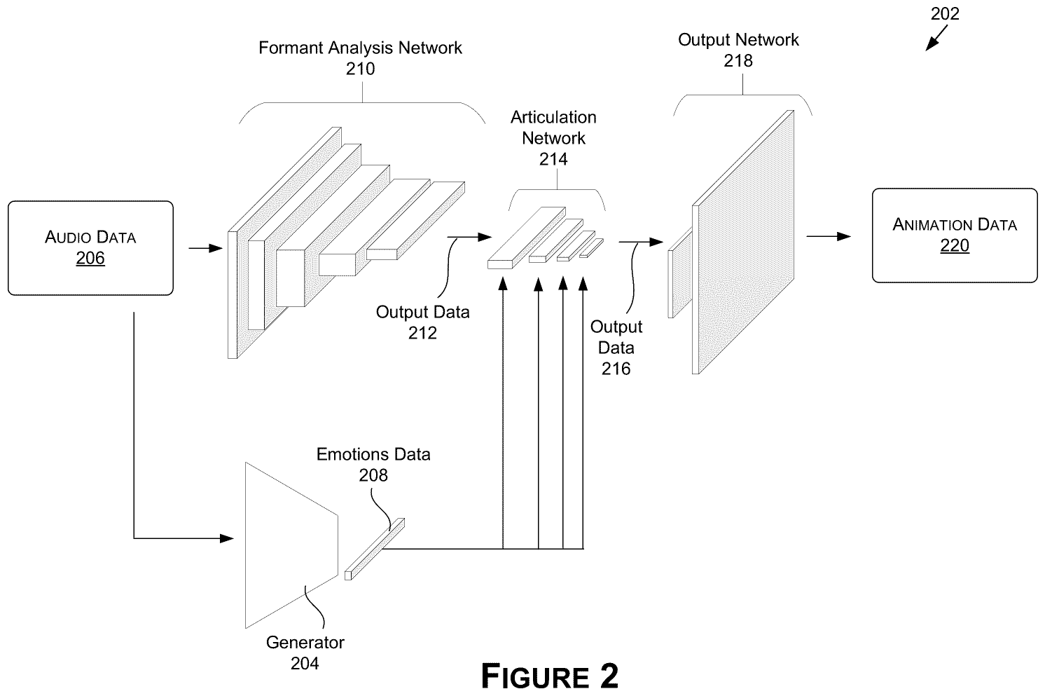

For an example of a neural network(s), FIG. 2 illustrates an example of a neural network(s) 202 used to animate a character using facial animations, in accordance with some embodiments of the present disclosure. As shown by the example of FIG. 2, the neural network(s) 202 may include a generator 204 (which may represent, and/or include, the second neural network(s) 108) that is configured to process audio data 206 (which may represent, and/or include, the audio data 102). Based at least on the processing, the generator 204 is configured to generate and then output emotions data 208 (which may represent, and/or include, the emotions data 110). In some examples, the emotions data 208 may represent one or more vectors associated with an implicit emotional state(s) (which may be represented in a latent space, as a vector embedding, for example). As described herein, an implicit emotional state may be associated with a neutral face (e.g., no emotion), a frowning face, a happy face, a sad face, a scared face, a face with closed eyes, a face with raised eyebrows, and/or a face that performs any other facial expression.

The neural network(s) 202 may also include a formant analysis network 210 (which may represent, and/or include, at least a portion of the third neural network(s) 112) that is configured to process the audio data 206. Based at least on processing the audio data 206, the formant analysis network 210 is configured to generate and then output data 212. While the example of FIG. 2 illustrates the generator 204 and the formant analysis network 210 directly processing the audio data 206, in some examples, the audio data 206 may initially be processed by one or more other networks. Additionally, while the example of FIG. 2 illustrates the formant analysis network 210 as including five layers, in other examples, the formant analysis network 210 may include any number of layers. Furthermore, while the example of FIG. 2 illustrates the formant analysis network 210 as operating as the backbone of the neural network(s) 202, in other examples, the backbone may include any other type of network.

The neural network(s) 202 may also include an articulation network 214 (which may represent, and/or include, at least a portion of the third neural network(s) 112) that is configured to process the emotions data 208 output by the generator 204 and the output data 212 from the formant analysis network 210. For instance, and as shown, the emotions data 208 may be input into one or more layers of the articulation network 214. Based at least on processing the emotions data 208 and the output data 212, the articulation network 214 is configured to generate and then output data 216. While the example of FIG. 2 illustrates the articulation network 214 as including four layers, in other examples, the articulation network 214 may include any number of layers.

The neural network(s) 202 may also include an output network(s) 218 (which may represent, and/or include, at least a portion of the third neural network(s) 112) that is configured to process the output data 216 from the articulation network 214. In some examples, the output network 218 may be configured to generate the final output associated with the neural network(s) 202. For instance, and as shown, based at least on processing the output data 216, the output network 218 may be configured to generate and then output animation data 220 (which may represent, and/or include, the animation data 114). As described herein, in some examples, the animation data 220 may represent a geometry dataset that includes (data corresponding to) a number of vertices associated with positions on a face for animating a character.

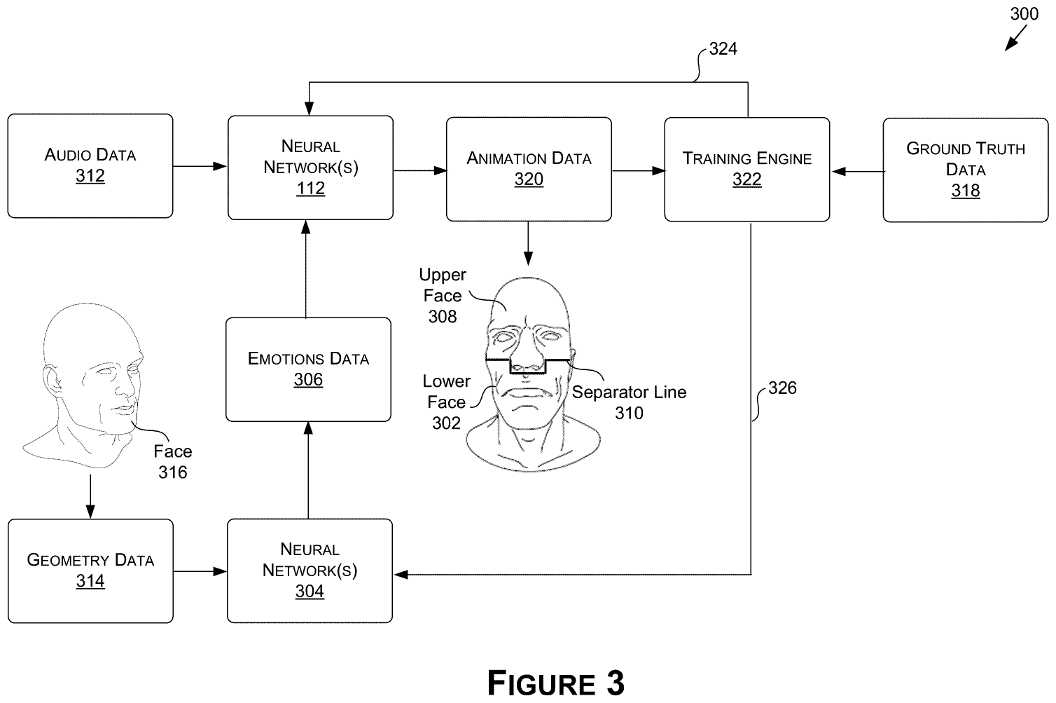

FIG. 3 is a data flow diagram illustrating a first process 300 for training a neural network(s) to animate a character using facial animations, in accordance with some embodiments of the present disclosure. As described herein, during the first process 300 of training, the third neural network(s) 112 may be trained to generate data that mostly and/or only drives a lower face 302 animation of a character and one or more neural networks 304 (which may be referred to, in some examples, as a “fourth neural network(s) 304”) may be trained to generate emotions data 306 that mostly and/or only drives an upper face 308 animation of the character, where the upper face 308 and the lower face 302 are separated—for visualization purposes—by a separator line 310 (however, the actual demarcation between upper and lower face may be different, and/or less clearly delineated in practice). As described herein, the fourth neural network(s) 304 may include, but is not limited to, an encoder neural network(s), a generator neural network(s), a convolutional neural network(s), a recurrent neural network(s), a transformer neural network(s), a feature-extracting neural network(s), a formant analysis neural network(s), a deep neural network(s), an articulation neural network(s), and/or any other type of network.

For instance, during a first training stage, audio data 312 (which may be similar to the audio data 102) may be input into the third neural network(s) 112 and geometry data 314 may be input into the fourth neural network(s) 304. In some examples, the geometry data 314 may represent a geometry dataset that includes a number of vertices associated with positions on one or more faces 316 (although only one is illustrated for clarity reasons). The number of vertices may include, but is not limited to, 100 vertices, 1,000 vertices, 60,000 vertices, 500,000 vertices, and/or any other number of vertices. Additionally, a vertex, from the number of vertices, may represent a 3D location of the position (or pose or orientation) on the face 316, such as a x-coordinate location, a y-coordinate location, and a z-coordinate location. Furthermore, in some examples, one or more techniques may be used in order to reduce the number of vertices represented by the geometry data 314. For example, PCA decomposition may be performed on the geometry dataset in order to reduce the dimensions of the output. The reduced dimension of the PCA coefficients may include, but is not limited to, 50, 100, 140, 500, 1,000, and/or any other dimension of coefficients. In some examples, additional data may be input into the third neural network(s) 112 and/or the fourth neural network(s) 304 during this first training stage, such as data representing explicit emotional labels. As described herein, an explicit emotional label may include, but is not limited to, neutral, joy, sad, amazement, anger, pain, disgust, fear, cheekiness, grief, and/or any other emotional state.

In some examples, since the first training stage is associated with training the third neural network(s) 112 to animate the lower facial expressions of the character, the audio data 312 may include “real” audio data 312 and the geometry data 314 may include “fake” or “synthetic” geometry data 314. For example, the geometry data 314 may not represent the actual geometry of a face when speech represented by the audio data 312 was spoken and/or the geometry data 314 may not match ground truth data 318 associated with the audio data 312. In some examples, the additional data, such as the data representing the explicit emotional states, may include “real” data or “fake” data. For example, if the data is real, then the data may represent the actual emotional state of the face when the speech was spoken. However, if the data is fake (or synthetic), then the data may not represent the actual emotional state of the face when the speech was spoken.

As shown, the fourth neural network(s) 304 may process the geometry data 314 and, based at least on the processing, output emotions data 306 (which may be similar to the emotions data 110). For example, the emotions data 306 may represent one or more vectors associated with one or more implicit emotional states. The third neural network(s) 112 may then process the audio data 312 and the emotions data 306 and, based at least on the processing, output animation data 320 (which may be similar to the animation data 114). For example, the animation data 320 may represent a geometry dataset that includes a number of vertices associated with positions on the face of the character. A training engine 322 may then use at least a portion of the animation data 320 and ground truth data 318 to train the third neural network(s) 112. As described herein, during the first training stage, the ground truth data 318 may represent a geometry dataset that includes a number of vertices associated with the actual geometry of the face that is associated with the audio data 312.

For instance, the training engine 322 may include one or more loss functions that measure a loss (e.g., error) in the at least the portion of the animation data 320 as compared to the ground truth data 318. In some examples, since the first training stage is associated with training the third neural network(s) 112 to animate the lower facial expressions of the character, at least the portion of the animation data 320 may include vertices associated with the lower face 302. Any type of loss function may be used by the training engine 322, such as cross entropy loss, mean squared error, mean absolute error, mean bias error, and/or other loss function types. The training engine 322 may then use the loss function(s) to train (e.g., update the parameters and/or weights of) the third neural network(s) 112 and/or the fourth neural network(s) 304, which is represented by 324 and/or 326.

During a second training stage, audio data 312 may again be input into the third neural network(s) 112 and geometry data 314 may again be input into the fourth neural network(s) 304. In some examples, additional data may be input into the third neural network(s) 112 and/or the fourth neural network(s) 304 during this second training stage, such as data representing explicit emotional states. In some examples, since the second training stage is associated with training the fourth neural network(s) 304 to animate the upper facial expressions of the character (e.g., generate emotions data 306 that accurately animates the upper facial expressions of the character), the audio data 312 may include “fake” audio data 312 and the geometry data 314 may include “real” geometry data 314. For example, the audio data 312 may not represent the speech that is associated with the geometry of the face. In some examples, the additional data, such as the data representing the explicit emotional states, may include “real” data or “fake” data. For example, if the data is real, then the data may represent the actual emotional state of the face that is associated with the geometry. However, if the data is fake, then the data may not represent the actual emotional state of the face that is associated with the geometry.

As shown, the fourth neural network(s) 304 may again process the geometry data 314 and, based at least on the processing, output emotions data 306 (which may be similar to the emotions data 110). For example, the emotions data 306 may represent one or more vectors associated with one or more implicit emotional states. The third neural network(s) 112 may also process the audio data 312 and the emotions data 306 and, based at least on the processing, output animation data 320 (which may be similar to the animation data 114). For example, the animation data 320 may represent a geometry dataset that includes a number of vertices associated with positions on the face of the character. The training engine 322 may then use at least a portion of the animation data 320 and ground truth data 318 to train the fourth neural network(s) 304. As described herein, during the second training stage, the ground truth data 318 may represent a geometry dataset that includes a number of vertices associated with the actual geometry of the face.

For instance, the training engine 322 may include one or more loss functions that measure a loss (e.g., error) in the at least the portion of the animation data 320 as compared to the ground truth data 318. In some examples, since the second training stage is associated with training the fourth neural network(s) 304 to animate the upper facial expressions of the character, the at least the portion of the animation data 320 may include vertices associated with the upper face 308. Any type of loss function may be used by the training engine 322, such as cross entropy loss, mean squared error, mean absolute error, mean bias error, and/or other loss function types. The training engine 322 may then use the loss function(s) to train (e.g., update the parameters—e.g., biases and/or weights—of) the third neural network(s) 112 and/or the fourth neural network(s) 304, which is represented by 324 and/or 326.

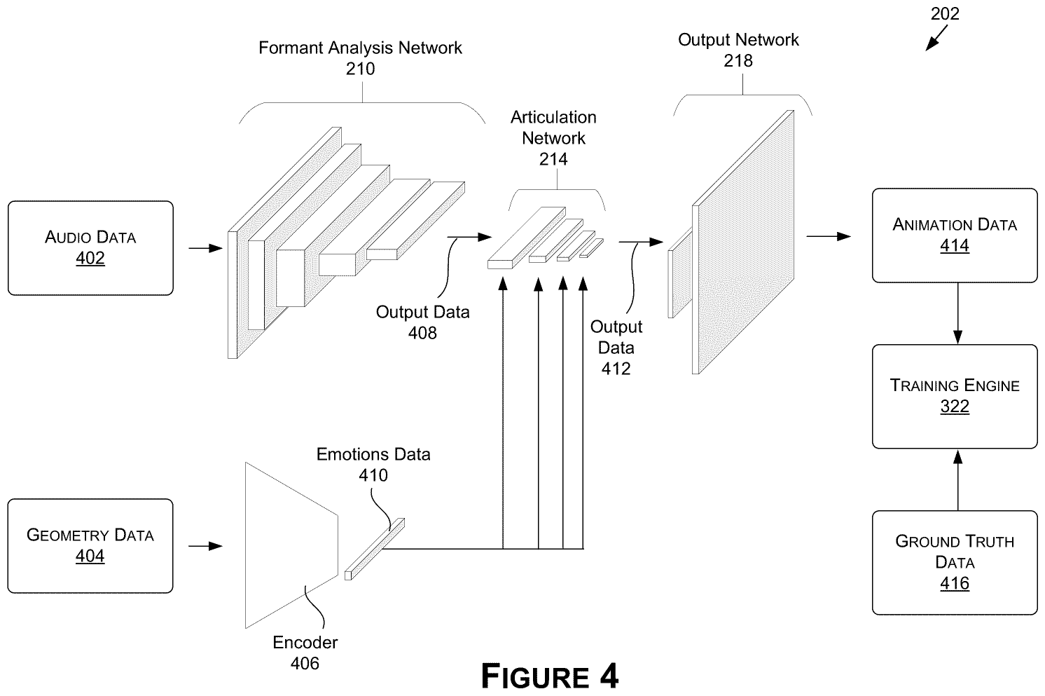

For instance, FIG. 4 illustrates an example of training the neural network(s) 202, in accordance with some embodiments of the present disclosure. In the example of FIG. 4, during the first training stage, “real” audio data 402 (which may represent, and/or include, the audio data 312) may be input into the formant analysis network 210 while “fake” geometry data 404 (which may represent, and/or include, the geometry data 314) may be input into an encoder 406 (which may represent, and/or include, the fourth neural network(s) 304). The formant analysis network 210 may then process the audio data 402 and, based at least on the processing, output data 408. Additionally, the encoder 406 may process the geometry data 404 and, based at least on the processing, output emotions data 410 (which may represent, and/or include the emotions data 306).

The articulation network 214 may then process the output data 408 from the formant analysis network 210 and the emotions data 410 output by the encoder 406. Based at least on the processing, the articulation network 214 may output data 412. Additionally, the output network 218 may process the output data 412 from the articulation network 214 and, based at least on the processing, output animation data 414 (which may represent, and/or include, the animation data 320). In some examples, the animation data 414 may represent vertices associated with an entirety of a face of a character. However, in other examples, since the first training stage is associated with training the lower facial expressions, the animation data 414 may represent vertices associated with the lower face of the character.

The training engine 322 may then use at least a portion of the animation data 414 and ground truth data 416 (which may represent, and/or include, the ground truth data 318) to train the formant analysis network 210, the articulation network 214, the output network 218, and/or the encoder 406. For instance, and as described herein, the ground truth data 416 may represent the actual geometry of the face that is associated with the audio data 402. As such, the training engine 322 may use a loss function(s) that measures a loss (e.g., error) in the at least the portion of the animation data 414 as compared to the ground truth data 416. The training engine 322 may then use the loss to update one or more parameters and/or one or more weights of the formant analysis network 210, the articulation network 214, the output network 218, and/or the encoder 406.

In the example of FIG. 4, during the second training stage, “fake” audio data 402 may be input into the formant analysis network 210 while “real” geometry data 404 may be input into the encoder 406. The formant analysis network 210 may then process the audio data 402 and, based at least on the processing, output data 408. Additionally, the encoder 406 may process the geometry data 404 and, based at least on the process, output emotions data 410.

The articulation network 214 may then process the output data 408 from the formant analysis network 210 and the emotions data 410 output by the encoder 406. Based at least on the processing, the articulation network 214 may output data 412. Additionally, the output network 218 may process the output data 412 from the articulation network 214 and, based at least on the processing, output animation data 414 (which may represent, and/or include, the animation data 320). In some examples, the animation data 414 may represent vertices associated with an entirety of a face of a character. However, in other examples, since the second training stage is associated with training the upper facial expressions, the animation data 414 may represent vertices associated with the upper face of the character.

The training engine 322 may then use at least a portion of the animation data 414 and ground truth data 416 to train the encoder 406 to generate more accurate emotions data 410. For instance, and as described herein, the ground truth data 416 may represent the actual geometry of the face that is associated with the geometry data 404. As such, the training engine 322 may use a loss function(s) that measures a loss (e.g., error) in the at least the portion of the animation data 414 as compared to the ground truth data 416. The training engine 322 may then use the loss to update one or more parameters and/or one or more weights the formant analysis network 210, the articulation network 214, the output network 218, and/or the encoder 406.

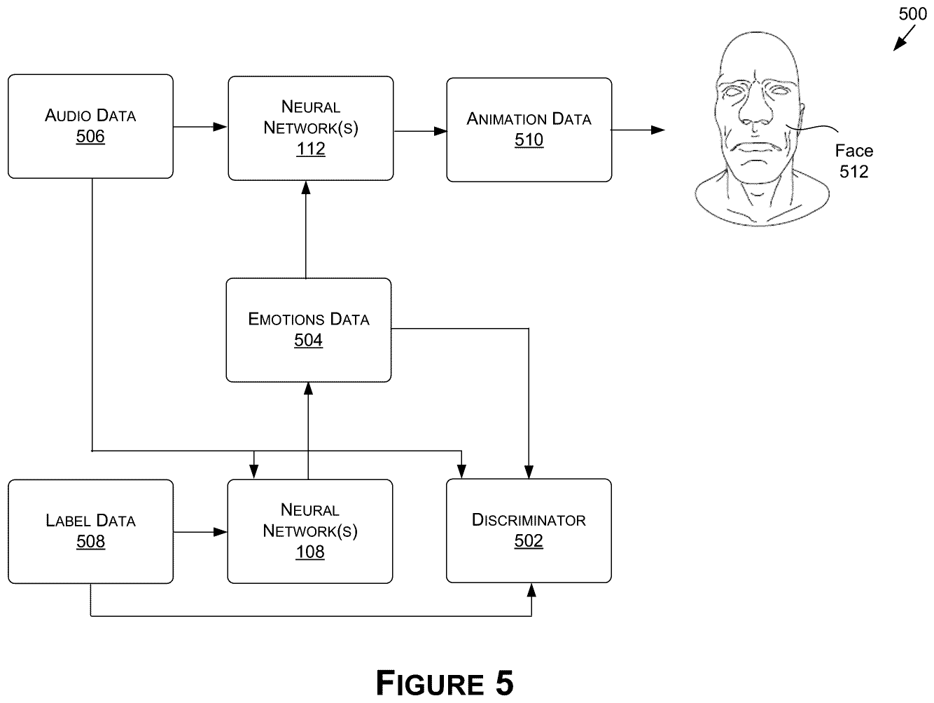

FIG. 5 is a data flow diagram illustrating a second process 500 for training a neural network(s) to animate a character using facial animations, in accordance with some embodiments of the present disclosure. For instance, and as described herein, during deployment, the second neural network(s) 108 may need to map audio data (e.g., the audio data 102) to implicit emotional states (e.g., represented by the emotions data 110). As such, the second process 500 of training may train the second neural network(s) 108 to perform such mapping. Additionally, in some examples, the second process 500 of training may be used to generate more expressive expressions, such as by applying adversarial training in order to learn a discriminator 502 to predict if the generated implicit emotional states, represented by emotions data 504 (which may be similar to the emotions data 110), are from one or more distributions and/or are from the same distribution of the training set.

As shown, the inputs associated with a third training stage may include audio data 506 (which may be similar to the audio data 102) that is input into the third neural network(s) 112, the second neural network(s) 108, and the discriminator 502. The inputs may also include label data 508 (e.g., explicit emotional label data) that is input into the second neural network(s) 108 and the discriminator 502. During the third stage of training, the second neural network(s) 108 may be configured to generate, based at least on processing the audio data 506, emotions data 504 that represents an implicit emotional state(s). Additionally, the discriminator 502 may be configured to determine whether the emotions data 504 is original input, such as the label data 508, or if the emotions data 504 is generated by the second neural network(s) 108. Furthermore, the discriminator 502 may be trained to determine whether the emotions data 504 is from an original data distribution (e.g., similar to the emotions data 410), or if the emotions data 504 is a fake one generated by the neural network(s) 108. As such, the third training stage may include training the second neural network(s) 108 and the discriminator 502 such that the second neural network(s) 108 is able to generate emotions data 504 at a level that the discriminator 502 is unable to and/or struggles to determine whether the emotions data 504 is generated by the second neural network(s) 108 or is the original label data 508. As such, the training engine 322 may update one or more parameters (e.g., biases and/or weights) associated with the second neural network(s) 108 and/or one or more parameters (e.g., biases and/or weights) associated with the discriminator 502 based on the determinations output by the discriminator 502. For example, the training engine 322 may update one or more parameters associated with the second neural network(s) 108 and/or one or more parameters associated with the discriminator 502 based on the loss (error) of the emotions data 504 and/or the animation data 510 as compared to ground truth data associated with the output emotions data 410 and/or the ground truth data 512.

While the example of FIG. 5 illustrates just one example technique of how the second neural network(s) 108 may be trained to generate emotions data 504 that represents the correct implicit emotional state(s), in other examples, the second neural network(s) 108 may be trained using one or more additional and/or alternative techniques. Additionally, and as also illustrated by the example of FIG. 5, during the third training stage, the process 500 may still include generating animation data 510 (which may be similar to the animation data 114) for animating a face 512 of a character. However, the third training stage may not include training the third neural network(s) 112 (e.g., the parameters of the third neural network(s) 112 may not be updated).

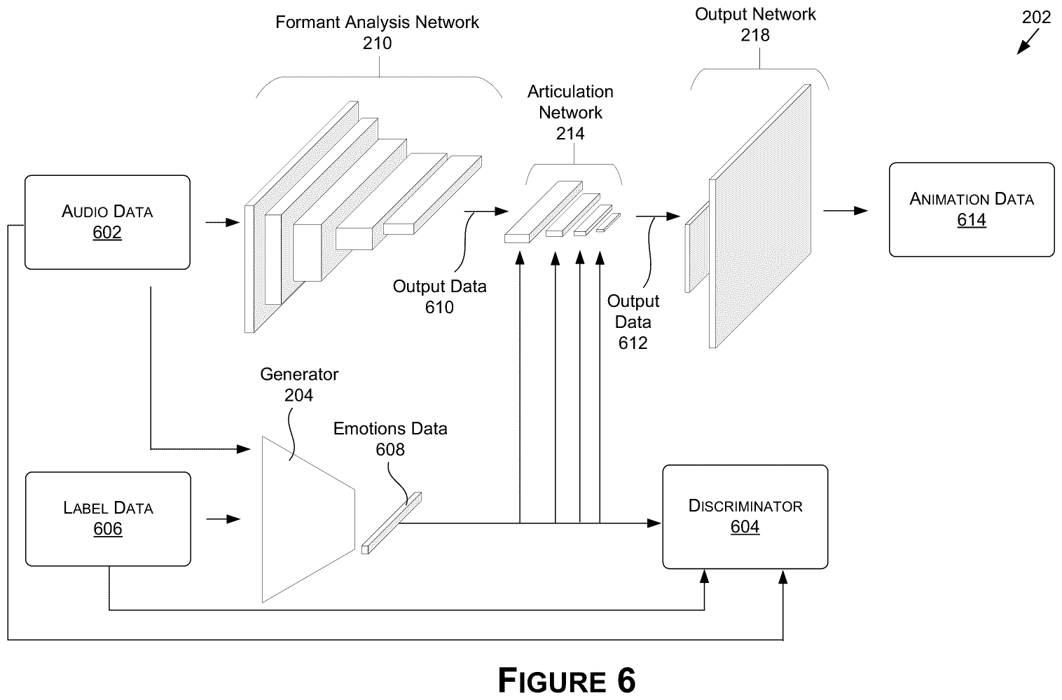

For instance, FIG. 6 illustrates an example of training the neural network(s) 202, in accordance with some embodiments of the present disclosure. In the example of FIG. 6, during a third training stage, audio data 602 (which may represent, and/or include, the audio data 506) may be input into the formant analysis network 210, the generator 204, and a discriminator 604 (which may represent, and/or include, the discriminator 502). Additionally, label data 606 (which may represent, and/or include, the label data 508) may be input into the generator 204 and the discriminator 604. The generator 204 may then be configured to process the audio data 602 and/or the label data 606. Based at least on the processing, the generator 204 may be configured to generate and then output emotions data 608 (which may represent, and/or include, the emotions data 504) representing one or more implicit emotional states.

In some examples, the discriminator 604 may then be configured to determine whether the emotions data 608 is from an original input distribution, such as the emotions data 410, or if the emotions data 608 is fake and generated by the generator 204. As such, the third training stage may include training the generator 204 and the discriminator 604 such that the generator 204 is able to generate emotions data 608 at a level that the discriminator 604 is unable to and/or struggles to determine whether the emotions data 608 is generated by the generator 204 or is from the original data distribution of emotions data 410. As such, the training engine 322 may update one or more parameters associated with the generator 204 and/or one or more parameters associated with the discriminator 604 based on the determinations output by the discriminator 604.

As further illustrated by the example of FIG. 6, during the third training stage, the formant analysis component 210 may process the audio data 602 and, based at least on the processing, output data 610. Additionally, the articulation network 214 may be configured to process the output data 610 from the formant analysis component 210 and the emotions data 608 from the generator 204 and, based at least on the processing, output data 612. Furthermore, the output network 218 may be configured to process the output data 612 from the articulation network 214 and, based at least on the processing, output animation data 614 (which may represent, and/or include, the animation data 510). The training engine 322 may then update one or more parameters associated with the second neural network(s) 108 and/or the discriminator 502 based on the loss (e.g., error) of the emotions data 504 and/or the animation data 510 as compared to ground truth data associated with the output emotions data 410 and/or the ground truth data 512. However, in some examples, the third training stage may not include training the formant analysis component 210, the articulation network 214, and/or the output network 218.

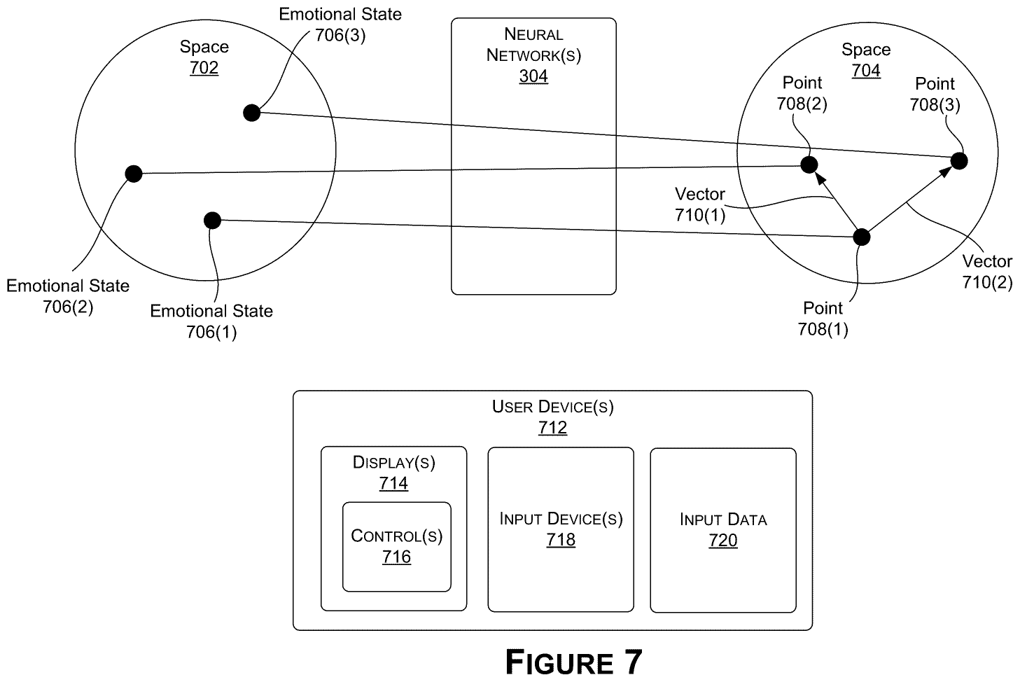

As described herein, in some examples, such as after training (e.g., after the first training stage, the second training stage, the third training stage, etc.), the user may be able to control the facial animations of an animated character. For instance, FIG. 7 illustrates an example of allowing a user to further control facial animations associated with animated characters, in accordance with some embodiments of the present disclosure.

As shown, the fourth neural network(s) 304 (and/or, in some examples, the second neural network(s) 108) is able to map datasets from a first space 702, such as geometry space and/or a PCA space, to a second space 704, such as an emotional latent space. For instance, the fourth neural network(s) 304 may map a first dataset associated with a first coefficient 706(1)) e.g., a first PCA coefficient 706(1)) from the first space 702 to a first state 708(1) (e.g., a first emotional state 708(1)) within the second space 704, map a second dataset associated with a second coefficient 706(2) (e.g., a second PCA coefficient 706(2)) from the first space 702 to a second state 708(2) (e.g., a second emotional state 708(2)) within the second space 704, and map a third dataset associated with a third coefficient 706(3) (e.g., a third PCA coefficient 706(3)) from the first space 702 to a third state 708(3) (e.g., a third emotional state 708(3)) within the second space 704. Additionally, the first estate 708(1) may include neutral state, such as a neutral face that is not showing any emotion, where the second state 708(2) and the third state 708(3) include states showing emotion. For example, the second state 708(2) may include closing eyes and the third state 708(3) may include frowning.

As such, a first vector 710(1) from the first state 708(1) to the second state 708(2) may include a vector that causes an animated character to animate, such as closing eyes. A second vector 710(2) from the first state 708(1) to the third state 708(3) may include a vector that causes the animated character to animate, such as frowning. Using these vectors 710(1)-(2), the user may then be able to control the facial animations associated with the animated character, such as by using linear manipulation.

For a first example, if the first vector 710(1) is associated with a factor of 1.0, then a user may provide one or more inputs that manipulate the first vector 710(1) to be associated with a factor of 0.5. As such, while the first vector 710(1) initially causes the animated character's eyes to close, the manipulated first vector 710(1) may only cause the animated character's eyes to partially close (e.g., halfway close in this example where the first vector 710(1) is manipulated by the factor of 0.5). For a second example, if the second vector 710(2) is associated with a factor of 1.0, then a user may provide one or more inputs that manipulate the second vector 710(2) to be associated with a factor of 0.7. As such, while the second vector 710(2) initially causes the animated character to fully frown, the manipulated second vector 710(2) may only cause the animated character to mostly frown (e.g., since the second vector 710(2) is manipulated by a factor of 0.7).

In some examples, the user may be able to manipulate the vectors 710(1)-(2) using one or more techniques. For example, one or more user device(s) 712 may use one or more displays 714 to present one or more controls 716 for manipulating the vectors 710(1)-(2). As described herein, a control 716 may include, but is not limited to, a slider, a button, an input field, and/or any other type of control that allows a user to input information, such as a factor. In some examples, the user provides the input using one or more input devices 718 associated with the user device(s) 712. As described herein, an input device 718 may include, but is not limited to, a button, a controller, a keyboard, a mouse, a microphone, a touch-sensitive display, and/or any other type of input device. In some examples, based on receiving an input, the user device(s) 712 may generate input data 720 representing the input and/or the factor.

In some examples, the input data 720 may then be used to control the facial animations associated with the animated character. For example, and referring back to the example of FIG. 1, the input data 720 may be used to generate emotions data 110 representing the manipulated vector. As such, the third neural network(s) 112 may generate the animation data 114 using the output data 106 and the emotions data 110 representing the manipulated vector. This way, the character 116, which may be animated using the display(s) 714, may be animated according to facial animation selected by the user.

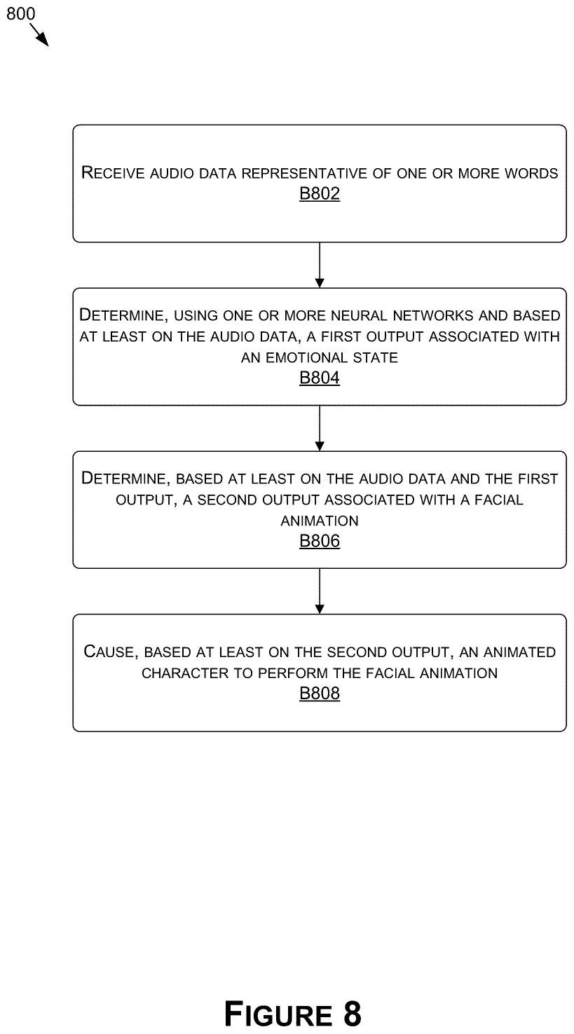

Now referring to FIGS. 8-10, each block of methods 800, 900, and 1000, described herein, comprises a computing process that may be performed using any combination of hardware, firmware, and/or software. For instance, various functions may be carried out by a processor executing instructions stored in memory. The methods 800, 900, and 1000 may also be embodied as computer-usable instructions stored on computer storage media. The methods 800, 900, and 1000 may be provided by a standalone application, a service or hosted service (standalone or in combination with another hosted service), or a plug-in to another product, to name a few. In addition, the methods 800, 900, and 900 may be executed by any one system, or any combination of systems, including, but not limited to, those described herein.

FIG. 8 is a flow diagram showing a method 800 for using a neural network(s) to animate a character using facial animations, in accordance with some embodiments of the present disclosure. The method 800, at block B802, may include receiving audio data representative of one or more words. For instance, the first neural network(s) 104, the second neural network(s) 108, and/or the third neural network(s) 112 may receive the audio data 102 representing the one or more words. In some examples, the word(s) are associated with user speech from one or more users. In some examples, the word(s) are computer generated. Still, in some examples, such as when the first neural network(s) 104 receives the audio data 102, the first neural network(s) 104 may process the audio data 102 in order to generate the output data 106. In any of these examples, the audio data 102 may represent a number of audio frames such as, but not limited to, 1 audio frame, 10 audio frames, 50 audio frames, 100 audio frames, 1,000 audio frames, and/or any other number of audio frames.

The method 800, at block B804, may include determining, using one or more neural networks and based at least on the audio data, a first output associated with an emotional state. For instance, the second neural network(s) 108 may process the audio data 102 (and/or the output data 106 if the first neural network(s) 104 already processed the audio data 102). Based at least on the processing, the second neural network(s) 108 may generate the emotions data 110 representing the emotional state, where the emotions data 110 corresponds to the first output.

The method 800, at block B806, may include determining, using the one or more neural networks and based at least on the audio data and the first output, a second output associated with a facial animation. For instance, the third neural network(s) 112 may process the audio data 102 (and/or the output data 106 if the first neural network(s) 104 already processed the audio data 102) and the emotions data 110. Based at least on the processing, the third neural network(s) 112 may generate the animation data 114, where the animation data 114 corresponds to the second output. For instance, and as described herein, the animation data 114 may represent a geometry dataset that includes a number of vertices associated with positions on a face of the animated character 116.

The method 800, at block B808, may include causing, based at least on the second output, an animated character to perform the facial animation. For instance, one or more devices (e.g., a computing device(s) 1102, the user device(s) 712, etc.) may use the animation data 114 to cause the animated character 116 to perform the facial animation. In some examples, the method 800 may then continue to repeat. For example, the method 800 may repeat in order to generate respective animation data 114 for groups of audio frames represented by the audio data 102. As described herein, a group of audio frames may include, but is not limited to, 1 audio frame, 2 audio frames, 5 audio frames, 10 audio frames, 100 audio frames, 1,000 audio frames, and/or any other number of audio frames.

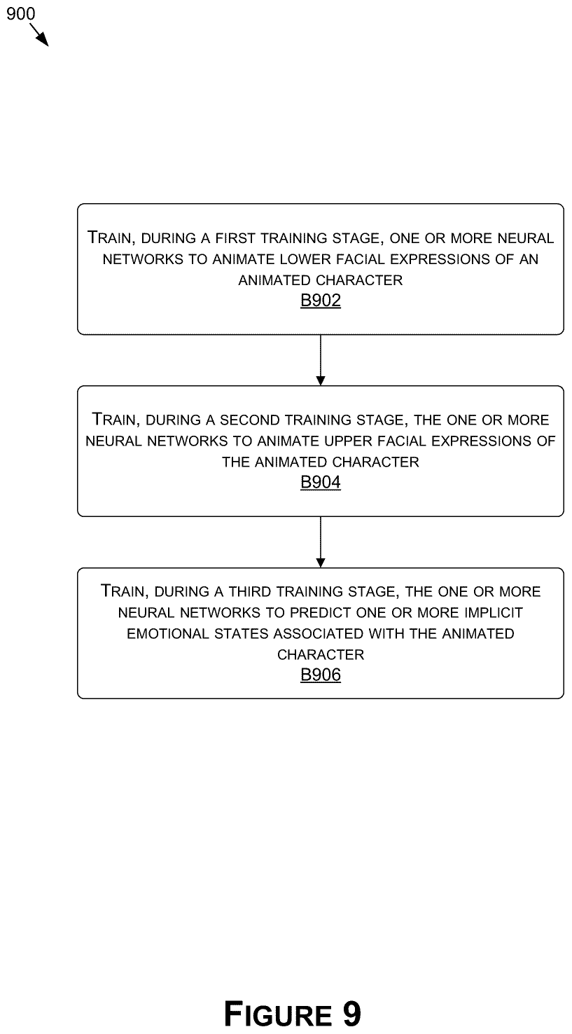

FIG. 9 is a flow diagram showing a method 900 for training a neural network(s) to animate a character using facial animations, in accordance with some embodiments of the present disclosure. The method 900, at block B902, may include training, during a first training stage, one or more neural networks to animate lower facial expressions of an animated character. For instance, a system(s) (e.g., the computing device(s) 1102, etc.) may train at least the third neural network(s) 112 and/or the fourth neural network(s) 304 to animate the lower facial expressions of the animated character. In some examples, the system(s) trains the third neural network(s) 112 and/or the fourth neural network(s) 304 using at least “real” audio data 312 and “fake” geometry data 314. Additionally, in some examples, the system(s) trains the third neural network(s) 112 and/or the fourth neural network(s) 304 using ground truth data 318 associated with the audio data 312.

The method 900, at block B904, may include training, during a second training stage, the one or more neural networks to animate upper facial expressions of the animated character. For instance, the system(s) (e.g., the computing device(s) 1102, etc.) may train at least the third neural network(s) 112 and/or the fourth neural network(s) 304 to animate the upper facial expressions of the animated character. In some examples, the system(s) trains the third neural network(s) 112 and/or the fourth neural network(s) 304 using at least “fake” audio data 312 and “real” geometry data 314. Additionally, in some examples, the system(s) trains the third neural network(s) 112 and/or the fourth neural network(s) 304 using ground truth data 318 associated with the geometry data 314.

The method 900, at block B906, may include training, during a third training stage, the one or more neural networks to predict one or more implicit emotional states associated with the animated character. For instance, the system(s) (e.g., the computing device(s) 1102, etc.) may train at least the second neural network(s) 108 to determine the implicit emotional state(s) represented by the emotions data 504. In some examples, the system(s) trains the second neural network(s) 108 using at least the audio data 506 and the label data 508. Additionally, in some examples, during the third training stage, the system(s) may perform additional training in order to generate more expressive expressions, such as by applying adversarial training in order to learn the discriminator 502 to predict if the generated implicit emotional states, represented by the emotions data 504, are from one or more real distributions.

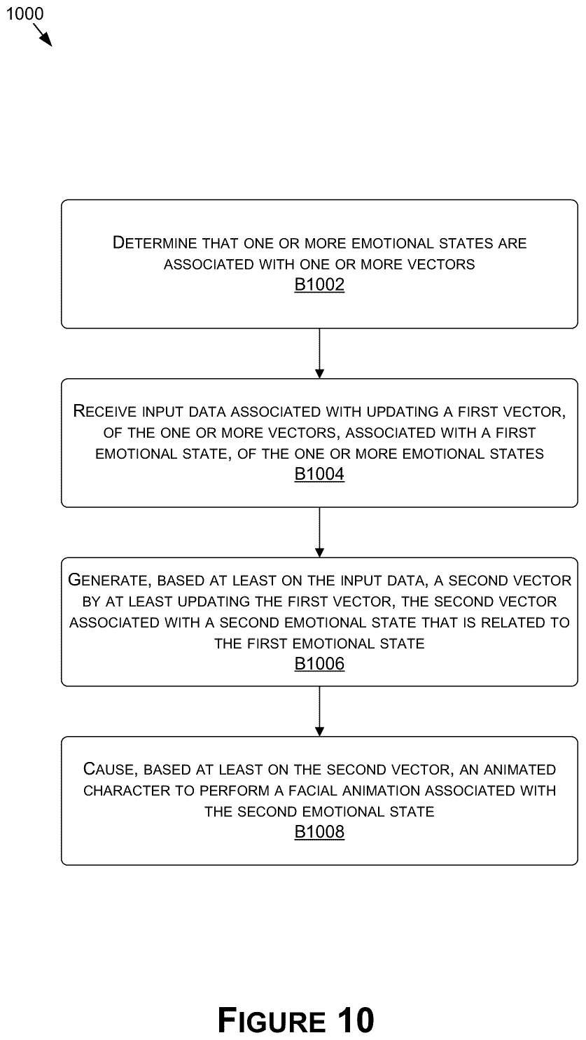

FIG. 10 is a flow diagram showing a method 1000 for controlling facial animations associated with an animated character, in accordance with some embodiments of the present disclosure. The method 1000, at block B1002, may include determining that one or more emotional states are associated with one or more vectors. For instance, the fourth neural network(s) 304 may map one or more datasets from a first space 702 (e.g., latent space, embedding space, etc.) to a second space 704 (e.g., latent space, embedding space, etc.), where the dataset(s) is associated with the state(s) 708. Based at least on the mapping, the vectors 710 may be determined, where the vectors 710 are associated with causing an animated character to perform one or more facial expressions associated with the state(s) 708, which is described herein.

The method 1000, at block B1004, may include receiving input data associated with updating a first vector, of the one or more vectors, associated with a first emotional state, of the one or more emotional states. For instance, one or more computing devices (e.g., the computing device(s) 1102, the user device(s) 712, etc.) may receive the input data 720 representing one or more inputs for updating the first vector 710 associated with the first state 708. In some examples, the input(s) may indicate a factor associated with manipulating the first vector 710.

The method 1000, at block B1006, may include generating, based at least on the input data, a second vector by updating the first vector, the second vector associated with a second emotional state that is related to the first emotional state. For instance, the computing device(s) (e.g., the computing device(s) 1102, the user device(s) 712, etc.) may use the input data 720 to update the vector 710 in order to generate the second vector 710. As described herein, the second vector 710 may be associated with causing the animated character to perform one or more facial expressions associated with the second state 708 that is related to the first state 708. For instance, the second state 708 may be the same as the first state 708, but at a different scale.

The method 1000, at block B1008, may include causing, based at least on the second vector, an animated character to perform a facial animation associated with the second emotional state. For instance, the third neural network(s) 112 may process audio data 102 and emotions data 110 representing the second vector 710. Based at least on the processing, the third neural network(s) 112 may generate animation data 114. The computing device(s) (e.g., the computing device(s) 1102, the user device(s) 712, etc.) may then use the animation data 114 to cause the animated character 116 to perform the facial animation associated with the second state 708.

### Example Content Streaming System

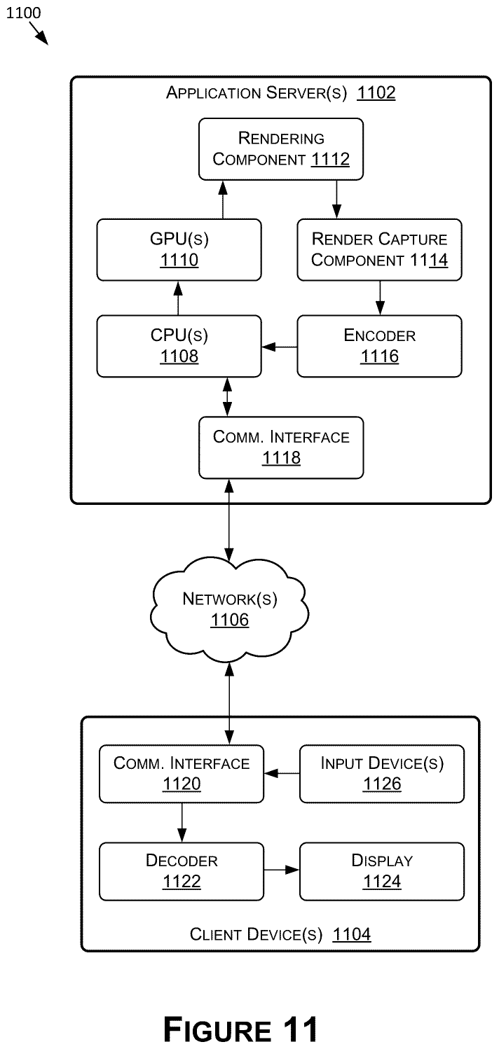

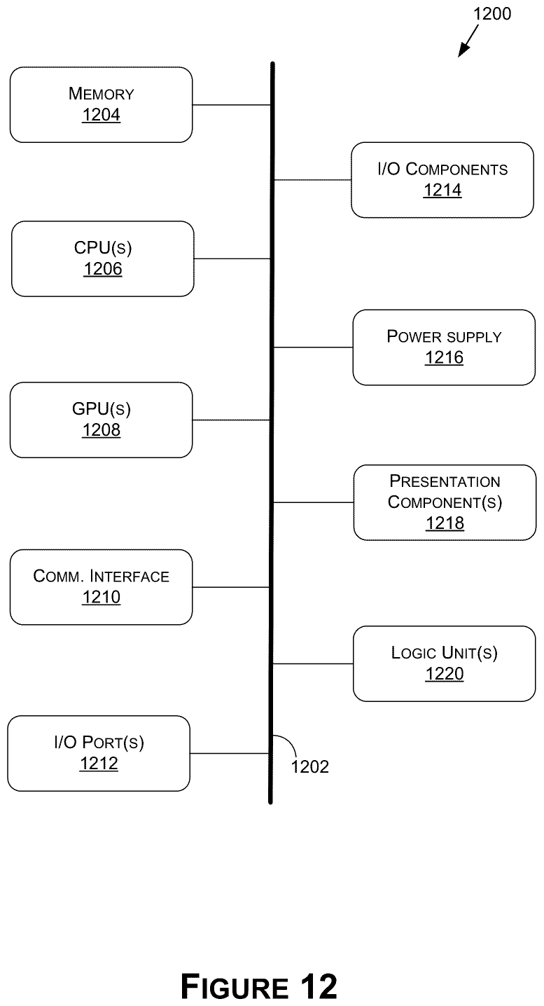

Now referring to FIG. 11, FIG. 11 is an example system diagram for a content streaming system 1100, in accordance with some embodiments of the present disclosure. FIG. 11 includes application server(s) 1102 (which may include similar components, features, and/or functionality to the example computing device 1200 of FIG. 12), client device(s) 1104 (which may include similar components, features, and/or functionality to the example computing device 1200 of FIG. 12), and network(s) 1106 (which may be similar to the network(s) described herein). In some embodiments of the present disclosure, the system 1100 may be implemented. The application session may correspond to a game streaming application (e.g., NVIDIA GeFORCE NOW), a remote desktop application, a simulation application (e.g., autonomous or semi-autonomous vehicle simulation), computer aided design (CAD) applications, virtual reality (VR) and/or augmented reality (AR) streaming applications, deep learning applications, and/or other application types.

In the system 1100, for an application session, the client device(s) 1104 may only receive input data in response to inputs to the input device(s), transmit the input data to the application server(s) 1102, receive encoded display data from the application server(s) 1102, and display the display data on the display 1124. As such, the more computationally intense computing and processing is offloaded to the application server(s) 1102 (e.g., rendering—in particular ray or path tracing—for graphical output of the application session is executed by the GPU(s) of the game server(s) 1102). In other words, the application session is streamed to the client device(s) 1104 from the application server(s) 1102, thereby reducing the requirements of the client device(s) 1104 for graphics processing and rendering.

For example, with respect to an instantiation of an application session, a client device 1104 may be displaying a frame of the application session on the display 1124 based on receiving the display data from the application server(s) 1102. The client device 1104 may receive an input to one of the input device(s) and generate input data in response. The client device 1104 may transmit the input data to the application server(s) 1102 via the communication interface 1120 and over the network(s) 1106 (e.g., the Internet), and the application server(s) 1102 may receive the input data via the communication interface 1118. The CPU(s) may receive the input data, process the input data, and transmit data to the GPU(s) that causes the GPU(s) to generate a rendering of the application session. For example, the input data may be representative of a movement of a character of the user in a game session of a game application, firing a weapon, reloading, passing a ball, turning a vehicle, etc. The rendering component 1112 may render the application session (e.g., representative of the result of the input data) and the render capture component 1114 may capture the rendering of the application session as display data (e.g., as image data capturing the rendered frame of the application session). The rendering of the application session may include ray or path-traced lighting and/or shadow effects, computed using one or more parallel processing units—such as GPUs, which may further employ the use of one or more dedicated hardware accelerators or processing cores to perform ray or path-tracing techniques—of the application server(s) 1102. In some embodiments, one or more virtual machines (VMs)—e.g., including one or more virtual components, such as vGPUs, vCPUs, etc.—may be used by the application server(s) 1102 to support the application sessions. The encoder 1116 may then encode the display data to generate encoded display data and the encoded display data may be transmitted to the client device 1104 over the network(s) 1106 via the communication interface 1118. The client device 1104 may receive the encoded display data via the communication interface 1120 and the decoder 1122 may decode the encoded display data to generate the display data. The client device 1104 may then display the display data via the display 1124.

The systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems implemented at least partially using cloud computing resources, and/or other types of systems.

### Example Computing Device

FIG. 12 is a block diagram of an example computing device(s) 1200 suitable for use in implementing some embodiments of the present disclosure. Computing device 1200 may include an interconnect system 1202 that directly or indirectly couples the following devices: memory 1204, one or more central processing units (CPUs) 1206, one or more graphics processing units (GPUs) 1208, a communication interface 1210, input/output (I/O) ports 1212, input/output components 1214, a power supply 1216, one or more presentation components 1218 (e.g., display(s)), and one or more logic units 1220. In at least one embodiment, the computing device(s) 1200 may comprise one or more virtual machines (VMs), and/or any of the components thereof may comprise virtual components (e.g., virtual hardware components). For non-limiting examples, one or more of the GPUs 1208 may comprise one or more vGPUs, one or more of the CPUs 1206 may comprise one or more vCPUs, and/or one or more of the logic units 1220 may comprise one or more virtual logic units. As such, a computing device(s) 1200 may include discrete components (e.g., a full GPU dedicated to the computing device 1200), virtual components (e.g., a portion of a GPU dedicated to the computing device 1200), or a combination thereof.

Although the various blocks of FIG. 12 are shown as connected via the interconnect system 1202 with lines, this is not intended to be limiting and is for clarity only. For example, in some embodiments, a presentation component 1218, such as a display device, may be considered an I/O component 1214 (e.g., if the display is a touch screen). As another example, the CPUs 1206 and/or GPUs 1208 may include memory (e.g., the memory 1204 may be representative of a storage device in addition to the memory of the GPUs 1208, the CPUs 1206, and/or other components). In other words, the computing device of FIG. 12 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 12.

The interconnect system 1202 may represent one or more links or busses, such as an address bus, a data bus, a control bus, or a combination thereof. The interconnect system 1202 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1206 may be directly connected to the memory 1204. Further, the CPU 1206 may be directly connected to the GPU 1208. Where there is direct, or point-to-point connection between components, the interconnect system 1202 may include a PCIe link to carry out the connection. In these examples, a PCI bus need not be included in the computing device 1200.

The memory 1204 may include any of a variety of computer-readable media. The computer-readable media may be any available media that may be accessed by the computing device 1200. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1204 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1200. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1206 may be configured to execute at least some of the computer-readable instructions to control one or more components of the computing device 1200 to perform one or more of the methods and/or processes described herein. The CPU(s) 1206 may each include one or more cores (e.g., one, two, four, eight, twenty-eight, seventy-two, etc.) that are capable of handling a multitude of software threads simultaneously. The CPU(s) 1206 may include any type of processor, and may include different types of processors depending on the type of computing device 1200 implemented (e.g., processors with fewer cores for mobile devices and processors with more cores for servers). For example, depending on the type of computing device 1200, the processor may be an Advanced RISC Machines (ARM) processor implemented using Reduced Instruction Set Computing (RISC) or an x86 processor implemented using Complex Instruction Set Computing (CISC). The computing device 1200 may include one or more CPUs 1206 in addition to one or more microprocessors or supplementary co-processors, such as math co-processors.

In addition to or alternatively from the CPU(s) 1206, the GPU(s) 1208 may be configured to execute at least some of the computer-readable instructions to control one or more components of the computing device 1200 to perform one or more of the methods and/or processes described herein. One or more of the GPU(s) 1208 may be an integrated GPU (e.g., with one or more of the CPU(s) 1206 and/or one or more of the GPU(s) 1208 may be a discrete GPU. In embodiments, one or more of the GPU(s) 1208 may be a coprocessor of one or more of the CPU(s) 1206. The GPU(s) 1208 may be used by the computing device 1200 to render graphics (e.g., 3D graphics) or perform general purpose computations. For example, the GPU(s) 1208 may be used for General-Purpose computing on GPUs (GPGPU). The GPU(s) 1208 may include hundreds or thousands of cores that are capable of handling hundreds or thousands of software threads simultaneously. The GPU(s) 1208 may generate pixel data for output images in response to rendering commands (e.g., rendering commands from the CPU(s) 1206 received via a host interface). The GPU(s) 1208 may include graphics memory, such as display memory, for storing pixel data or any other suitable data, such as GPGPU data. The display memory may be included as part of the memory 1204. The GPU(s) 1208 may include two or more GPUs operating in parallel (e.g., via a link). The link may directly connect the GPUs (e.g., using NVLINK) or may connect the GPUs through a switch (e.g., using NVSwitch). When combined together, each GPU 1208 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1206 and/or the GPU(s) 1208, the logic unit(s) 1220 may be configured to execute at least some of the computer-readable instructions to control one or more components of the computing device 1200 to perform one or more of the methods and/or processes described herein. In embodiments, the CPU(s) 1206, the GPU(s) 1208, and/or the logic unit(s) 1220 may discretely or jointly perform any combination of the methods, processes and/or portions thereof. One or more of the logic units 1220 may be part of and/or integrated in one or more of the CPU(s) 1206 and/or the GPU(s) 1208 and/or one or more of the logic units 1220 may be discrete components or otherwise external to the CPU(s) 1206 and/or the GPU(s) 1208. In embodiments, one or more of the logic units 1220 may be a coprocessor of one or more of the CPU(s) 1206 and/or one or more of the GPU(s) 1208.

Examples of the logic unit(s) 1220 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1210 may include one or more receivers, transmitters, and/or transceivers that enable the computing device 1200 to communicate with other computing devices via an electronic communication network, included wired and/or wireless communications. The communication interface 1210 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1220 and/or communication interface 1210 may include one or more data processing units (DPUs) to transmit data received over a network and/or through interconnect system 1202 directly to (e.g., a memory of) one or more GPU(s) 1208.

The I/O ports 1212 may enable the computing device 1200 to be logically coupled to other devices including the I/O components 1214, the presentation component(s) 1218, and/or other components, some of which may be built in to (e.g., integrated in) the computing device 1200. Illustrative I/O components 1214 include a microphone, mouse, keyboard, joystick, game pad, game controller, satellite dish, scanner, printer, wireless device, etc. The I/O components 1214 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1200. The computing device 1200 may be include depth cameras, such as stereoscopic camera systems, infrared camera systems, RGB camera systems, touchscreen technology, and combinations of these, for gesture detection and recognition. Additionally, the computing device 1200 may include accelerometers or gyroscopes (e.g., as part of an inertia measurement unit (IMU)) that enable detection of motion. In some examples, the output of the accelerometers or gyroscopes may be used by the computing device 1200 to render immersive augmented reality or virtual reality.

The power supply 1216 may include a hard-wired power supply, a battery power supply, or a combination thereof. The power supply 1216 may provide power to the computing device 1200 to enable the components of the computing device 1200 to operate.

The presentation component(s) 1218 may include a display (e.g., a monitor, a touch screen, a television screen, a heads-up-display (HUD), other display types, or a combination thereof), speakers, and/or other presentation components. The presentation component(s) 1218 may receive data from other components (e.g., the GPU(s) 1208, the CPU(s) 1206, DPUs, etc.), and output the data (e.g., as an image, video, sound, etc.).

### Example Data Center

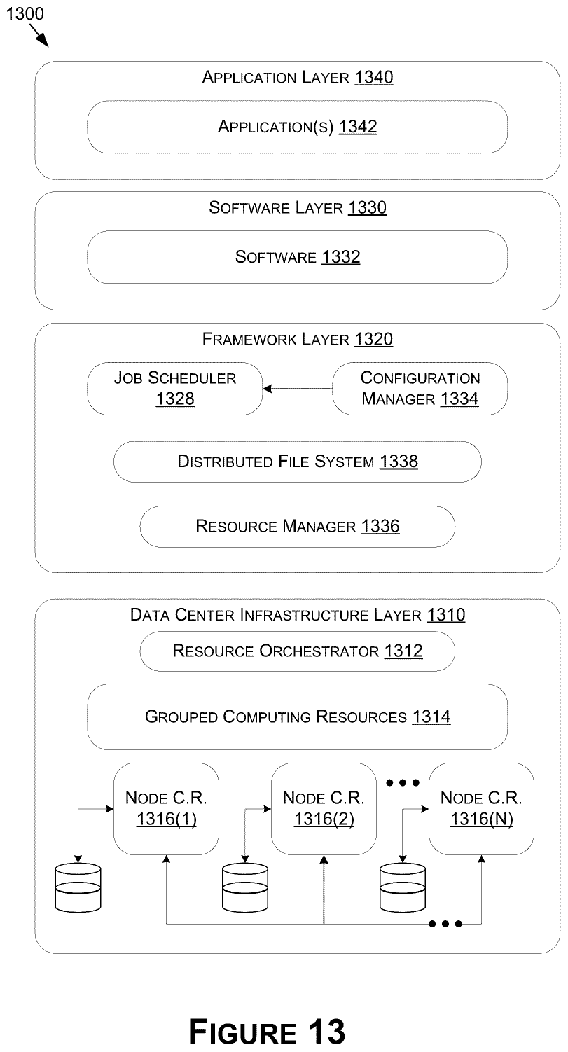

FIG. 13 illustrates an example data center 1300 that may be used in at least one embodiments of the present disclosure. The data center 1300 may include a data center infrastructure layer 1310, a framework layer 1320, a software layer 1330, and/or an application layer 1340.

As shown in FIG. 13, the data center infrastructure layer 1310 may include a resource orchestrator 1312, grouped computing resources 1314, and node computing resources (“node C.R.s”) 1316(1)-1316(N), where “N” represents any whole, positive integer. In at least one embodiment, node C.R.s 1316(1)-1316(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1316(1)-1316 (N) may correspond to a server having one or more of the above-mentioned computing resources. In addition, in some embodiments, the node C.R.s 1316(1)-13161(N) may include one or more virtual components, such as vGPUs, vCPUs, and/or the like, and/or one or more of the node C.R.s 1316(1)-1316(N) may correspond to a virtual machine (VM).

In at least one embodiment, grouped computing resources 1314 may include separate groupings of node C.R.s 1316 housed within one or more racks (not shown), or many racks housed in data centers at various geographical locations (also not shown). Separate groupings of node C.R.s 1316 within grouped computing resources 1314 may include grouped compute, network, memory or storage resources that may be configured or allocated to support one or more workloads. In at least one embodiment, several node C.R.s 1316 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1312 may configure or otherwise control one or more node C.R.s 1316(1)-1316(N) and/or grouped computing resources 1314. In at least one embodiment, resource orchestrator 1312 may include a software design infrastructure (SDI) management entity for the data center 1300. The resource orchestrator 1312 may include hardware, software, or some combination thereof.

In at least one embodiment, as shown in FIG. 13, framework layer 1320 may include a job scheduler 1328, a configuration manager 1334, a resource manager 1336, and/or a distributed file system 1338. The framework layer 1320 may include a framework to support software 1332 of software layer 1330 and/or one or more application(s) 1342 of application layer 1340. The software 1332 or application(s) 1342 may respectively include web-based service software or applications, such as those provided by Amazon Web Services, Google Cloud and Microsoft Azure. The framework layer 1320 may be, but is not limited to, a type of free and open-source software web application framework such as Apache Spark™ (hereinafter “Spark”) that may utilize distributed file system 1338 for large-scale data processing (e.g., “big data”). In at least one embodiment, job scheduler 1328 may include a Spark driver to facilitate scheduling of workloads supported by various layers of data center 1300. The configuration manager 1334 may be capable of configuring different layers such as software layer 1330 and framework layer 1320 including Spark and distributed file system 1338 for supporting large-scale data processing. The resource manager 1336 may be capable of managing clustered or grouped computing resources mapped to or allocated for support of distributed file system 1338 and job scheduler 1328. In at least one embodiment, clustered or grouped computing resources may include grouped computing resource 1314 at data center infrastructure layer 1310. The resource manager 1336 may coordinate with resource orchestrator 1312 to manage these mapped or allocated computing resources.

In at least one embodiment, software 1332 included in software layer 1330 may include software used by at least portions of node C.R.s 1316(1)-1316(N), grouped computing resources 1314, and/or distributed file system 1338 of framework layer 1320. One or more types of software may include, but are not limited to, Internet web page search software, e-mail virus scan software, database software, and streaming video content software.

In at least one embodiment, application(s) 1342 included in application layer 1340 may include one or more types of applications used by at least portions of node C.R.s 1316(1)-1316(N), grouped computing resources 1314, and/or distributed file system 1338 of framework layer 1320. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1334, resource manager 1336, and resource orchestrator 1312 may implement any number and type of self-modifying actions based on any amount and type of data acquired in any technically feasible fashion. Self-modifying actions may relieve a data center operator of data center 1300 from making possibly bad configuration decisions and possibly avoiding underutilized and/or poor performing portions of a data center.

The data center 1300 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1300. In at least one embodiment, trained or deployed machine learning models corresponding to one or more neural networks may be used to infer or predict information using resources described above with respect to the data center 1300 by using weight parameters calculated through one or more training techniques, such as but not limited to those described herein.

In at least one embodiment, the data center 1300 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1200 of FIG. 12—e.g., each device may include similar components, features, and/or functionality of the computing device(s) 1200. In addition, where backend devices (e.g., servers, NAS, etc.) are implemented, the backend devices may be included as part of a data center 1300, an example of which is described in more detail herein with respect to FIG. 13.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1200 described herein with respect to FIG. 12. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. A method comprising:
generating, using one or more first neural networks and based at least on audio data corresponding to one or more words, a first output associated with an emotional state;
determining, using one or more second neural networks and based at least on the audio data and the first output, a second output associated with a facial animation; and
causing, based at least on the second output, an animated character to perform the facial animation.

2. The method of claim 1, wherein the second output corresponds to locations of a plurality of vertices, an individual vertex of the plurality of vertices representing a three-dimensional point associated with a face of the animated character.

3. The method of claim 1, further comprising:
determining, using one or more third neural networks and based at least on the audio data, a third output,
wherein:
the determining the first output associated with the emotional state is based at least on the third output; and
the determining the second output associated with the facial animation is based at least on the first output and the third output.

4. The method of claim 1, wherein the determining the second output associated with the facial animation comprises:
determining, using at least one third neural network of the one or more second neural networks, and based at least on the audio data and the first output, a third output; and
determining, using at least one fourth neural network of the one or more second neural networks, and based at least on the third output, the second output associated with a facial animation.

5. The method of claim 1, further comprising:
generating, using the one or more first neural networks and based at least on second audio data corresponding to one or more second words, a third output associated with at least one of the emotional state or a second emotional state;
determining, using the one or more second neural networks and based at least on the second audio data and the third output, a fourth output associated with a second facial animation; and
causing, based at least on the fourth output, the animated character to perform the second facial animation.

6. The method of claim 1, wherein:
the one or more first neural networks are trained based at least on animating a first portion of a face of the animated character; and
the one or more second neural networks are trained based at least on animating a second portion of the face of the animated character.

7. The method of claim 6, wherein:
the first portion of the face includes at least one of one or more eyes, a nose, or one or more eyebrows of the face; and
the second portion of the face includes at least one of a mouth, one or more cheeks, or a chin of the face.

8. The method of claim 1, wherein the one or more first neural networks are trained using adversarial training in order to learn a discriminator that predicts if the emotional state is from a distribution.

9. A system comprising:
one or more processing units to:
determine, using one or more neural networks and based at least on audio data corresponding to one or more sounds, a first output associated with an emotional state;
determine, using the one or more neural networks and based at least on the audio data and the first output, a second output associated with animating a face of a character; and
cause, based at least on the second output, an animation of the face of the character.

10. The system of claim 9, wherein the second output represents locations of a plurality of vertices, an individual vertex of the plurality of vertices representing a three-dimensional point associated with the face of the character.

11. The system of claim 9, wherein the one or more processing units are further to
determine, using one or more second neural networks and based at least on the audio data, a third output,
wherein the determination of the first output associated with the emotional state is based at least on the third output, and wherein the determination of the second output associated with animating the face of the character is based at least on the third output and the second output.

12. The system of claim 9 wherein the one or more processing units are further to
determine, using the one or more neural networks and based at least on second audio data corresponding to one or more second sounds, a third output associated with at least one of the emotional state or a second emotional state;
determine, using the one or more neural networks and based at least on the second audio data and the third output, a fourth output associated with animating the face of the character; and
cause, based at least on the fourth output, a second animation of the face of the character.

13. The system of claim 9, wherein:
the determination of the first output associated with the emotional state uses one or more first neural networks of the one or more neural networks; and
the determination of the second output associated with animating the face of the character uses one or more second neural networks of the one or more neural networks.

14. The system of claim 9, wherein the one or more processing units are further to:
receive input data representative of one or more inputs; and
generate, based at least on the input data, a third output by updating at least a portion of the first output,
wherein the determination of the second output associated with animating the face of the character is based at least on the audio data and the third output.

15. The system of claim 13, wherein:
the one or more first neural networks are trained based at least on animating a first portion of the face of the character; and
the one or more second neural networks are trained based at least on animating a second portion of the face of the character.

16. The system of claim 9, wherein:
the one or more neural networks are trained using a first loss function that is associated with a first portion of the face of the character; and
the one or more neural networks are trained using a second loss function that is associated with a second portion of the face of the character.

17. The system of claim 9, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a robot;
a system implemented using one or more large language models;
a system for performing conversational AI operations;
a system for generating synthetic data;
a system incorporating one or more virtual machines (VMs);
a system implemented at least partially in a data center; or
a system implemented at least partially using cloud computing resources.

18. A processor comprising:
one or more processing units to generate, using one or more first neural networks and based at least on audio data and a first output associated with an emotional state, a second output associated with animating a face of an animated character, wherein the first output is generated using one or more second neural networks and based at least on the audio data.

19. The processor of claim 18, wherein:
the one or more first neural networks are trained based at least on animating a first portion of the face of the animated character; and
the one or more second neural networks are trained based at least on animating a second portion of the face of the animated character.

20. The processor of claim 18, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a robot;
a system implemented using one or more large language models;
a system for performing conversational AI operations;
a system for generating synthetic data;
a system incorporating one or more virtual machines (VMs);
a system implemented at least partially in a data center; or
a system implemented at least partially using cloud computing resources.
